(19) United States
(12) Patent Application Publication
(10) Pub. No.: US 2002/0110133 A1
(43) Pub. Date: Aug. 15, 2002

(54) Front-end service for selecting intelligent network services

(76) Inventor: Tomas Bern, Allen, TX (US)

Correspondence Address: Raymond Van Dyke, Jenkens & Gilchrist, P.C., 3200 Fountain Place, 1445 Ross Avenue, Dallas, TX, 75202-2799, US

(21) Appl. No.: 09/738,225

(22) Filed: Dec. 15, 2000

(51) Int. Cl. H04L 12/28; H04L 12/56; H04J 3/16; H04J 3/22; H04J 3/12

(52) U.S. Cl. 370/410; 370/466; 370/522

(57) ABSTRACT

A method and system for selecting among the intelligent network services provided by a plurality of service control points are disclosed. Upon placing or receiving a call, a front-end service in a service control point determines which intelligent network services are to be rendered. The front-end service then identifies the service control points that are to perform the subscribed intelligent network services and transfers control of the call to the servicing service control points. A communication link between the service control points allows the call to be transferred between the service control points.

### BACKGROUND OF THE INVENTION

1. Technical Field of the Invention

The present invention relates to providing intelligent network services and, in particular, to a method of selecting among a plurality of available intelligent network services.

2. Description of Related Art

An intelligent network (IN) in the context of a telecommunications system refers to a network wherein telecommunications services are distributed across a number of independent nodes. Each node, called a service control point (SCP), provides one or more services such as private prepaid service (PPS), call forwarding, voice mail, one-number dialing, mobile virtual private network (MVPN), and service restrictions such as call blocking (hereinafter “IN services”). Such a nodal architecture has many advantages including manageability of the nodes in that each node may be independently controlled by a service provider associated therewith, and network flexibility in that new service nodes may be easily added to the network.

FIG. 1 illustrates a relevant portion of an IN-based mobile telecommunications system 10. The system 10 includes a mobile switching center (MSC) 11 which is linked to the public switch telephone network (PSTN) and the public land mobile network (PLMN) 12. The MSC 11 connects calls between a user 13 (represented by the mobile phone icon) of the mobile telecommunications system 10 and other users on both the PSTN and PLMN 12. A home location register (HLR) 14 stores user profiles 15 containing various information about the user 13 (e.g., mobile unit ID, supplementary services, etc.) needed to identify and service the user 13 within the mobile telecommunications system 10.

When the user 13 makes an outgoing call or receives an incoming call (represented by the jagged line), the MSC 11 (which has already downloaded the appropriate user profile 15 upon registration from the HLR 14) retrieves information regarding the calling/called party. Upon detecting in the user profile 15 that the user has a subscription to an IN service, the MSC 11 invokes a switching service function (SSF) 16 in the MSC 11. The SSF 16 is basically an interface between the MSC 11 and the SCP 17 for triggering or activating the IN services provided by the SCP 17. Control of the call is thereafter passed to the SCP 17 via a network connection 18 in order that the subscribed IN services may be rendered.

However, the nature of an IN-based telecommunications system, as is well known to those of ordinary skill in the art, is such that each user therein is required to be associated with only one node IN service. This node will be referred to herein as the primary node. Thus, in the mobile telecommunications system 10 shown in FIG. 1, the user 13 is associated only with one SCP 17, namely, SCP1. As such, the user 13 has access only to those IN services provided by SCP1, for example, MVPN service. If the user 13 wishes to have access to IN services not available from SCP1, such as PPS, then the subscription to SCP1 must be canceled and replaced with a subscription to a different SCP 19, for example, SCP2. The network connection to SCP2 is represented here by a dashed line to emphasize the point that the user 13 may be associated only with one node at a time.

Although changing service provider is an option, from the user's standpoint, such a change can involve a lot of hassle. Typically, the user must obtain a new 10-digit directory number corresponding to the dialing prefix of the new SCP, which necessitates that friends and associates be contacted and informed of the new number. Oftentimes there is a fee or set up cost associated with such a change. Similarly, a new service provider wishing to introduce a novel or unique IN service is compelled to also provide existing IN services. Otherwise, the new service provider would be hard pressed to persuade satisfied users to give up existing IN services in order to switch over to the new service. Moreover, in case a first SCP provides one set of IN services and a second SCP provides another set of IN services, a user is forced to evaluate and choose between one set or the other set, but not both.

Accordingly, it is desirable to be able to provide a way to select IN services from a plurality of SCPs. More particularly, it is desirable to be able to select from the IN services of these different SCPs without changing the current or primary SCP.

### SUMMARY OF THE INVENTION

The present invention is directed to a method and system for selecting among the IN services provided by a plurality of SCPs. Upon placing or receiving a call, a front-end service in an SCP determines which IN services are to be rendered. The front-end service then identifies the SCPs that are to perform the subscribed IN services and transfers control of the call to the servicing SCPs. A telecommunications link between the SCPs allows the call to be transferred between SCPs.

In one aspect, the invention is directed to a method for selecting intelligent network services in a mobile telecommunications system. The method comprises the steps of connecting a wireless communication to a first network service provider and requesting at least one intelligent network service be provided to the wireless communication by the first network service provider. The wireless communication is then connected to a second network service provider via the first network service provider if the at least one intelligent network service cannot be provided to the wireless communication by the first network service provider.

In another aspect, the invention is directed to a system for selecting intelligent network services in a mobile telecommunications system. The system comprises a first telecommunications node having a front-end service executing therein and a mobile switching center configured to connect a wireless communication to the first telecommunications node, the front-end service requesting at least one intelligent network service be provided to the wireless communication by the first telecommunications node. A second telecommunications node is linked to the first telecommunications node, wherein the front-end service is configured to connect the wireless communication to the second telecommunications node via the first telecommunications node if the at least one intelligent network service cannot be provided to the wireless communication by the first telecommunications node.

### BRIEF DESCRIPTION OF THE DRAWINGS

A more complete understanding of the method and apparatus of the present invention may be had by reference to the following detailed description when taken in conjunction with the accompanying drawings wherein:

FIG. 1 illustrates a prior art IN based mobile telecommunications system;

FIG. 2 illustrates an IN based mobile telecommunications system according to an embodiment of the present invention;

FIG. 3 illustrates a user profile;

FIG. 4 illustrates an IN service selector according to an embodiment of the present invention;

FIG. 5 illustrates a subscriber profile according to an embodiment of the present invention;

FIG. 6 illustrates a call origination method according to an embodiment of the present invention;

FIGS. 7A-7B illustrate an IN service processing method in accordance with the method of FIG. 6;

FIG. 8 illustrates a call termination method according to an embodiment of the present invention;

FIG. 9 illustrates a user-initiated IN subscriber profile modification method according to an embodiment of the present invention; and

FIG. 10 illustrates a network-initiated IN subscriber profile modification method according to an embodiment of the present invention.

### DETAILED DESCRIPTION OF PRESENTLY PREFERRED EMBODIMENTS

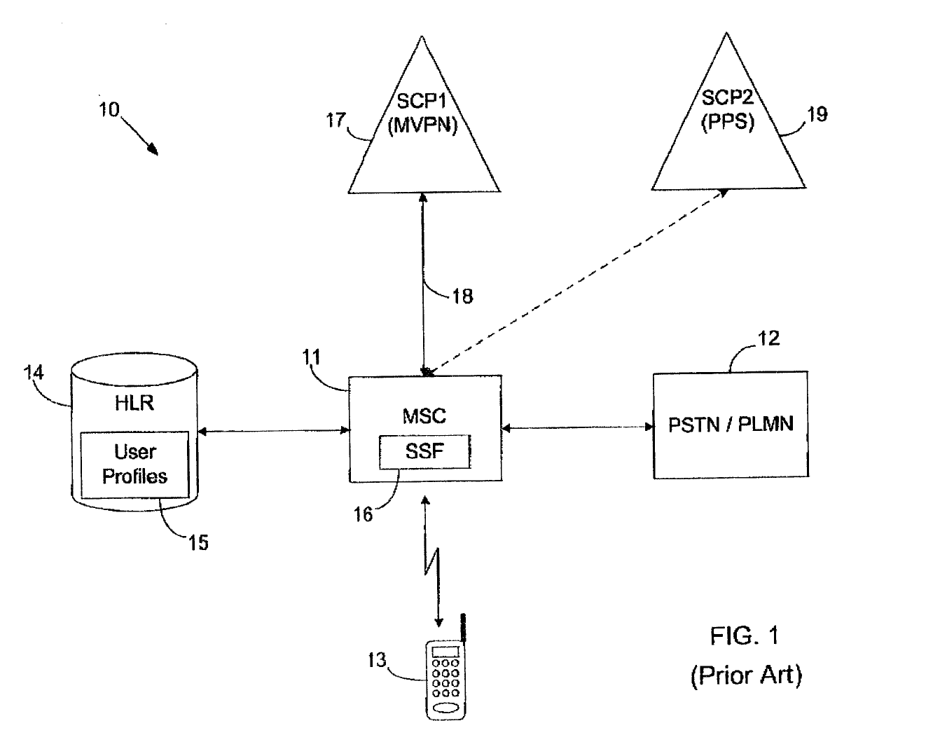

The preferred embodiment of the present invention and its advantages are best understood by referring to FIGS. 1-10 of the drawings wherein like numerals are used for like and corresponding parts of the various drawings.

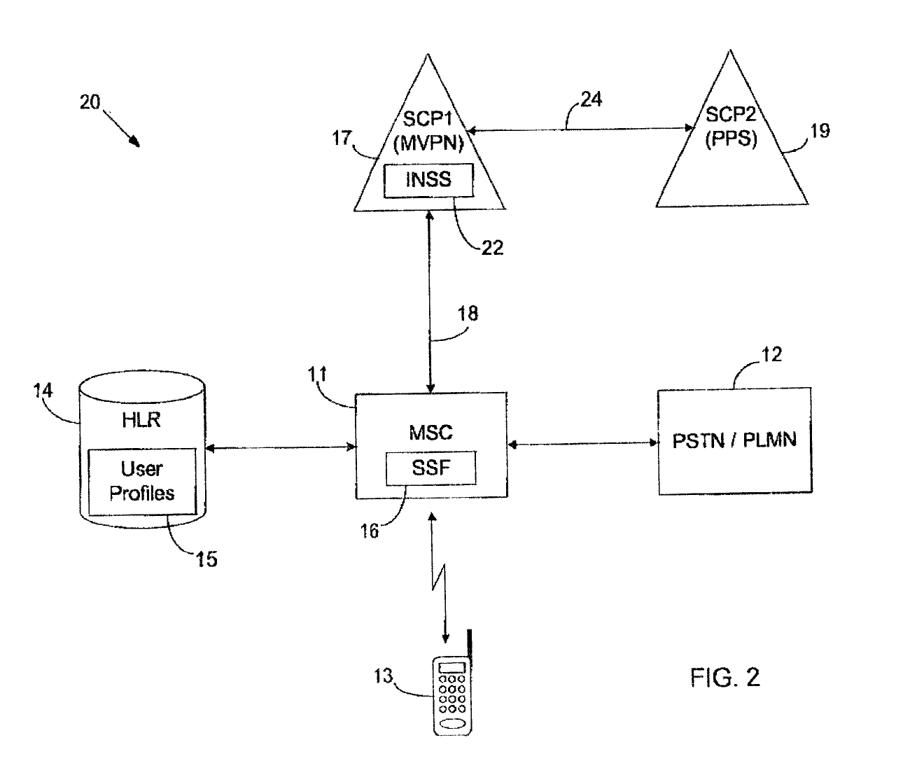

As mentioned previously, the present invention provides a method and system for selecting from among a plurality of IN services in a plurality of SCPs. Referring now to FIG. 2, an IN based mobile telecommunications system 20 according to an embodiment of the present invention is shown. The exemplary system 20 is similar to the system 10 with the exception that an IN service selector (INSS) 22 resides within SCP1. The INSS 22 serves as a front-end service to allow users to select from a multitude of IN services belonging to a plurality of SCPs without having to change or replace the primary SCP regardless of which particular SCP is the eventual service provider. A telecommunications link 24 between SCP1 and SCP2 facilitates the exchange of data including the transfer of calls therebetween. Although the INSS 22 is shown as residing in SCP1, the invention is not limited thereto and it should be noted that either or both of the SCPs may have an INSS residing therein. However, the INSS 22 may have a different INSS prefix associated therewith depending on which SCP is the primary SCP.

Because the INSS is itself a service provided by SCP1, the users 13 of the system 20 who wish to avail themselves of the service may do so through a subscription plan similar to the subscriptions for regular IN services. Like regular IN services, INSS subscription information may be stored in and accessed from the user profiles 15 stored in the HLR 14 each time a call is placed or received by the user 13.

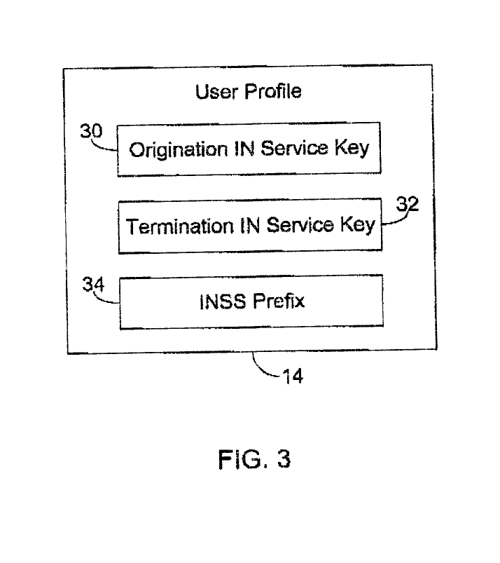

An exemplary user profile 15 is shown in FIG. 3. As mentioned previously, the user profile 15 contains information for identifying and servicing the user 13 within the mobile telecommunications system 20. For economy of the Drawings, this information is not shown here. In addition, the user profile 15 also includes an origination IN service key 30, a termination IN service key 32, and the INSS prefix 34 corresponding to the particular SCP providing the front-end IN selection service. As will be described more fully later, the origination and termination INSS service keys 30 and 32 are used by the INSS 22 to determine which IN services are to be performed when a call is placed or received. In some embodiments, the origination and termination INSS service keys 30 and 32 may be a part of, or indicated by, the origination IN category key (OICK) and the termination IN category key (TICK), respectively, in the Ericsson CME20/CMS40 systems.

The above INSS subscription information can be used to access the INSS 22 in SCP1 whenever the user 13 makes an outgoing call or receives an incoming call. Upon the occurrence of either an outgoing call or an incoming call, the MSC 11 downloads the user's profile 15 from the HLR 14. If the call is originated by the user 13, the MSC 11 will detect the origination IN service key 30. Likewise, if the call is terminated, or received, by the user 13, the MSC 11 will detect the termination IN service key 32. When either of these keys are detected, the MSC 11 is alerted to the fact that the user 13 has an IN service subscription. The MSC 11 will thereafter invoke the SSF 16 to handle the communication with SCP1.

The SSF 16, once invoked, contacts SCP1 and begins a dialogue therewith. The SSF 16 then sends the calling/called party's directory number along with the INSS subscription information contained in the user profile 15 to SCP1. Upon receiving this information, the INSS 22 executing in SCP1 begins processing of the IN service request.

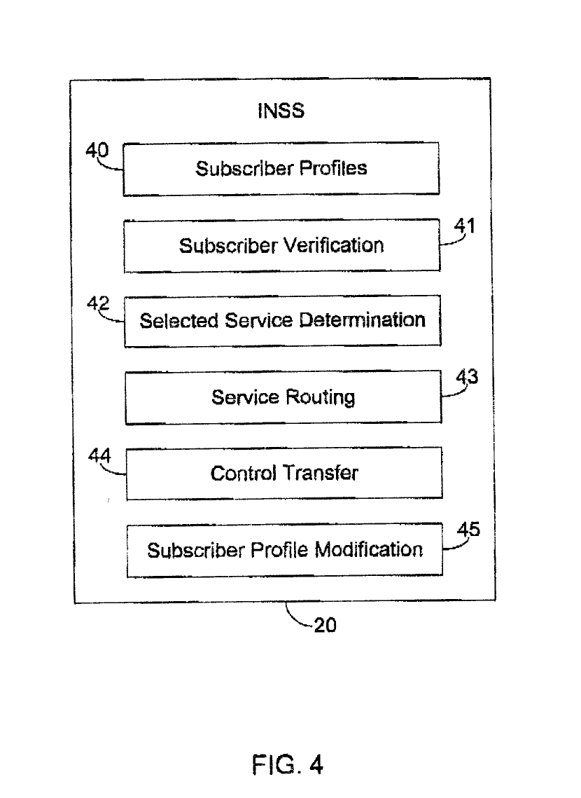

A more detailed explanation of the INSS 22 may be obtained with reference to FIG. 4. As can be seen, the INSS 22 has a number of functional components or modules, including the INSS subscriber profiles 40, a subscriber verification module 41, a service determination module 42, a service routing module 43, an SCP transfer module 44, and a subscriber profile modification module 45.

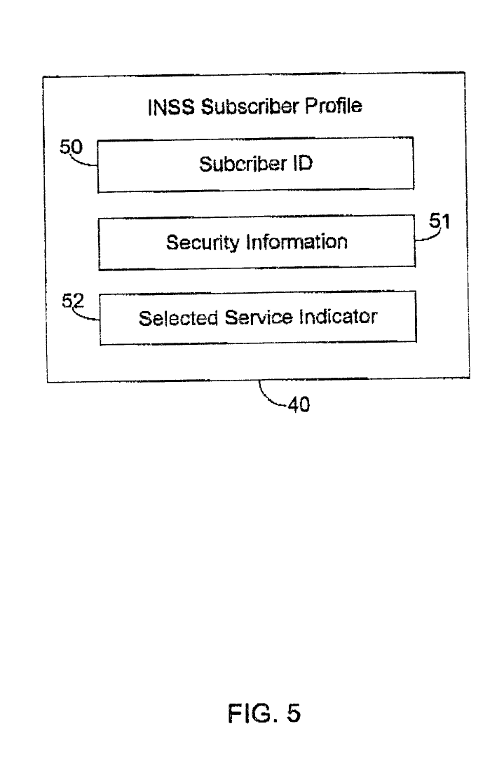

The INSS subscriber profiles 40 are stored in SCP1 and include subscription information for the users who have subscribed to the front-end service provided by SCP1. Specifically, referring temporarily to FIG. 5, each INSS subscriber profile 40 includes a subscriber ID 50 which is used to determine which IN services have been subscribed to by the user. The subscriber ID 50 may be any unique identifying number, but in an exemplary embodiment, the subscriber ID 50 is made up of the INSS prefix 34 and the user's 10-digit directory number appended thereto.

The INSS subscriber profile 40 also includes security information 51 and an indicator 52 that indicates which IN services have been subscribed to for both origination and termination calls. In some embodiments, the indicator 52 reflects IN services that have been selected by the user. In other embodiments, the indicator 52 reflects IN services that have been preset by, for example, a system administrator of SCP1. Both of these components are discussed further below.

Referring back to FIG. 4, the subscriber verification module 41 operates to verify that the user indeed has a subscription to the INSS service. In an exemplary embodiment, the verification module 41 assembles a temporary number made of the calling/called party's directory number received from the SSF 16 appended to the INSS prefix 34. The SSF 16 then compares this temporary number to the subscriber ID 50 in each of the subscriber profiles 40. If there is a match, the INSS 22 continues processing of the call. Otherwise, processing of the call is terminated.

Once the user 13 has been verified as a subscriber (i.e., call processing continues), the service determination module 42 is responsible for determining which services are to be provided to the user 13. In an exemplary embodiment, the service determination module 42 uses a two-digit number for the selected service indicator 52, wherein the value of each digit reflects an IN service type selection. This embodiment may be made clearer by considering an example of a company that has equipped its employees with mobile phones. The company wishes to provide to the employees both MVPN service for work related calls and PPS service for personal calls. TABLE 1 below shows the selected service indicators that may be used in such a scenario:

TABLE 1

| Indicator | | |
|---|---|---|
| (Company + Subscriber) | Outlet | Selected Service |
| 01 | A | MVPN |
| 02 | B | PPS |
| 1x | A | MVRN |
| 1x | A | MVRN |
| 2x | B | PPS |
| 2x | B | PPS |

In the table, 0=not applicable, 1=MVPN, 2=PPS, and x=don't care. As can be seen, for indicator values that are less than 10, the subscriber selected IN services will be performed. However, for indicator values that are equal to or greater than 10, the company selected IN services will be performed. Thus, the company selected services will control unless no service is specified by the company. This can be useful for the company, for example, during business hours when it may wish to specify only MVPN service be provided. Similarly, on the weekend, the company may wish to specify only PPS service be provided. At all other times, the company may wish to allow the employees to select the services provided.

The outlet values are included here simply as an indication of which SCP will perform the selected IN services, with ‘A’ indicating one SCP and ‘B’ indicating another SCP. It should, of course, be understood that both services, MVPN and PPS, may coexist on the same SCP.

Alternatively, once the user has been verified as a subscriber, the service determination module 43 may prompt the user for the choice of selected services instead of retrieving this information from the subscriber profiles. For example, in one embodiment, one or more prerecorded voice announcements may ask the user to select the desired IN services after verification is completed. The user may then respond by, for example, pressing the appropriate DTMF keys on the mobile unit. The user's responses are then collected by the service detection module 43 to be used to render the selected IN services.

In either case, once the selected services are determined, the IN service routing module 43 selects which SCPs are to provide the selected services. In some cases, only certain SCPs can provide the selected service. In the mobile telecommunications system 20 of FIG. 2, for example, only SCP1 can provide MVPN service, while only SCP2 can provide PPS service. In such cases, the service routing module 43 simply selects the SCPs that can provide the selected IN services.

In other cases, however, the mobile telecommunications system has been set up such that more than one SCP may provide the same IN service based on, for example, the calling/called directory number of the user. TABLE 2 below illustrates this scenario for PPS service:

TABLE 2

| Directory Number | SCP# |
|---|---|
| 972-583-xxxx | 2 |
| 972-584-xxxx | 2 |
| 972-585-xxxx | 3 |
| 972-586-xxxx | 3 |

As can be seen, the mobile telecommunications system has been set up such that SCP2 can provide PPS service for the '583 and '584 series directory numbers, whereas SCP3 can provide the same PPS service for the '585 and '586 series directory numbers. Thus, which SCP will provide a particular IN service may depend on the directory number of the user.

Once the service routing module 43 has determined which SCP will provide which service for a given call, the call is routed to the appropriate SCP. For example, if the IN service to be provided resides on the current or primary SCP, then that SCP simply carries out the requested IN service. However, if the IN service to be provided resides on another SCP, then the service routing module 43 establishes a communication link, such as the communication link 24 in FIG. 2, between the servicing SCP and the current SCP. The service routing module 43 thereafter appends the network address of the servicing SCP to the call data, and forwards the call to the servicing SCP.

After the call has been appropriately routed, control of the call is transferred by the control transfer module 44 to the servicing SCP. From this point forward, the call is controlled entirely by the servicing SCP. However, the call itself will still be routed through the primary SCP in order to arrive at the servicing SCP. In this way, the primary SCP subscription may be maintained even though a specific IN service may be provided by a different SCP.

Turning now to the subscriber profile modification module 45, this module allows a user who is a subscriber to the front-end service provided by the SCP to modify the selected services indicated in the subscriber profile. To accomplish this, the user simply dials a predetermined number that includes the prefix of the subscribed INSS 40. The INSS 40 then prompts the user through one or more prerecorded voice announcements to enter the new IN services. The user responds to the voice announcement by pressing the appropriate DTMF keys on the mobile unit.

Typically, if the user is calling from his own mobile units, then minimal or no security authorization need be performed to allow the user to change his selected IN services. However, if the user is calling from a unit other than his mobile unit, the subscriber profile modification module 45 may request the user provide evidence of security authorization such as a password. The module 45 then compares this information with the security information 51 contained in the subscriber profile of the user. If the security information does not agree, then after an appropriate number of unsuccessful attempts, the module 45 will terminate the call.

In addition to the user, the SCP itself may be allowed to change the subscriber profiles of the users. In the case of the company mentioned previously, the company may wish to have the SCP automatically change the selected services in the subscriber profiles of the users based on some criteria, for example, the time of day, or the day of the week. In this embodiment, the SCP monitors the specified metric (e.g., time), and when the change criteria are met, the SCP automatically changes the selected services (or rather the indicator thereof) in the subscriber profiles of the users. Again, this type of feature is useful for companies that provide mobile phone services for its employees because it allows the company to control when and which IN services are rendered.

Discussion of the invention thus far have been centered on various system level embodiments. Following is a description of a number of methods that may be used to practice the invention.

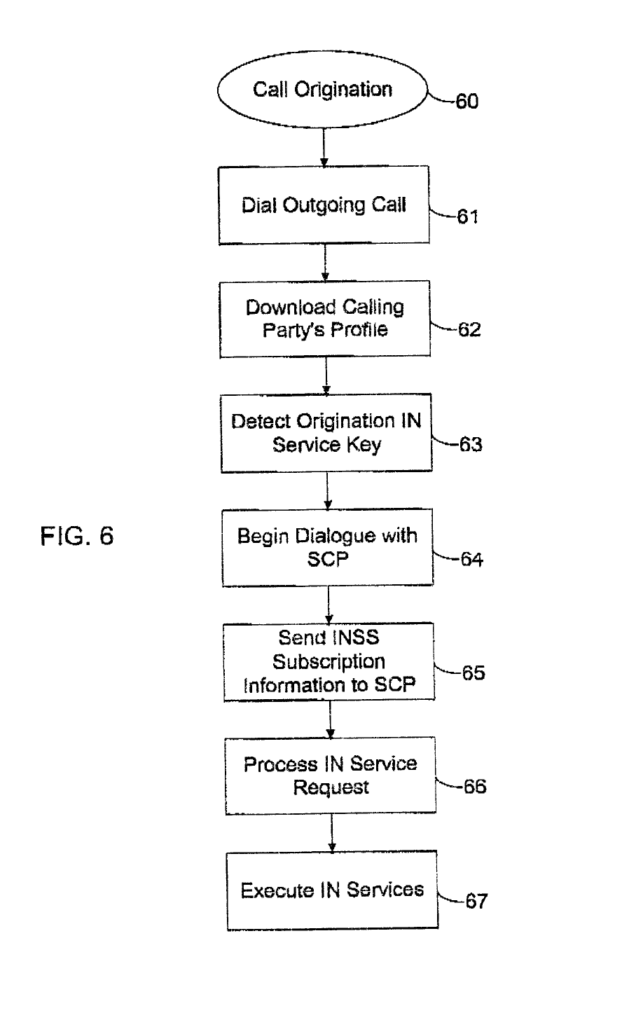

Referring now to FIG. 6, a method 60 is shown for selecting IN services where a call is originated by the user. At step 61, a user of a mobile station dials an outgoing call. The MSC, upon receiving the dialed call, downloads the user's profile from the HLR at step 62. At step 63, the MSC detects from the user's profile the origination IN service key. The MSC thereafter invokes the SSF at step 64, which begins a dialog with the SCP. The SSF then sends the user's INSS subscription information to the SCP at step 65. At step 66, the INSS executing on the SCP begins processing the IN service request upon receiving the INSS subscription information from the SSF. Once the INSS has identified the IN services that are to be provided to the user, these IN services are routed to and performed by their respective SCPs at step 67.

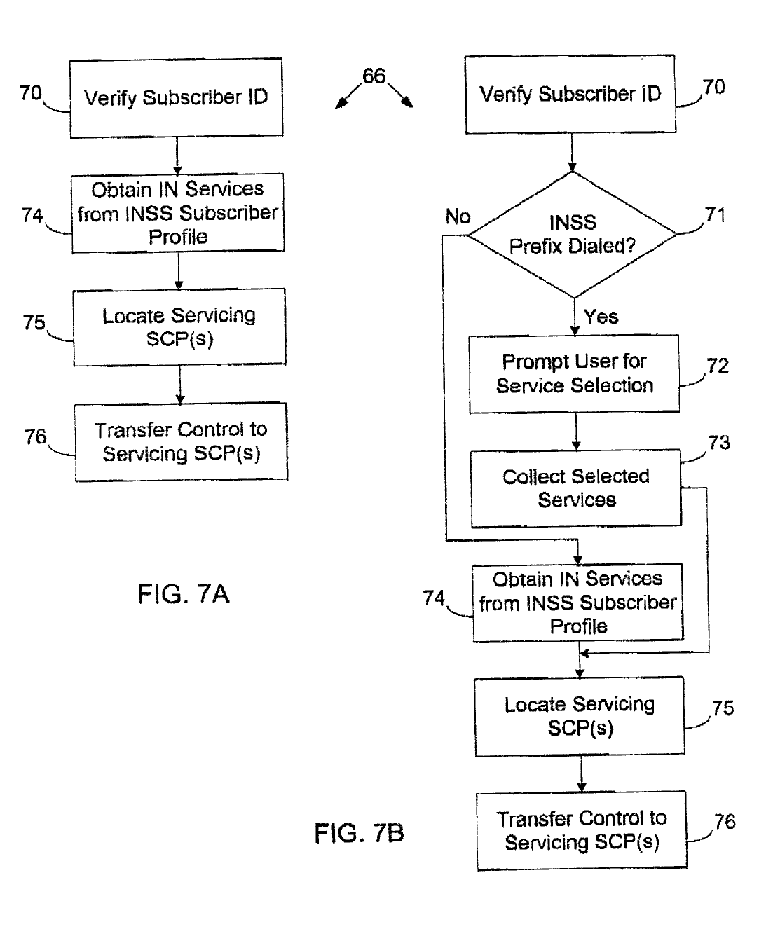

A more detailed explanation of the processing of the IN service request at step 66 may be had with reference to FIGS. 7A-7B. Referring now to FIG. 7A, at step 70, the INSS verifies the received subscriber information against the information in the subscriber profiles stored in the SCP. At step 74, the particular IN services to which the user has subscribed is determined from the subscriber profile in the manner described previously. At step 75, the INSS locates the servicing SCPs and, if the servicing SCPs are other than the current or primary SCP, the INSS transfers control of the call to the servicing SCP at step 76.

Alternatively, referring now to FIG. 7B, instead of the INSS identifying which IN services to provide, the user may be prompted to select the IN services. Thus, at step 71, a determination is made as to whether the INSS prefix was dialed. If yes, the user is prompted in the manner described above to enter his choices of selected IN services at step 72. The user's responses (e.g., via DTMF keys) are collected at step 73. The method then jumps to step 75 where the serving SCPs for the selected services are located. From there, the method proceeds as described above in FIG. 7A. If the answer is “No” at step 71, then the method jumps to step 74 and proceeds once again as described in FIG. 7A.

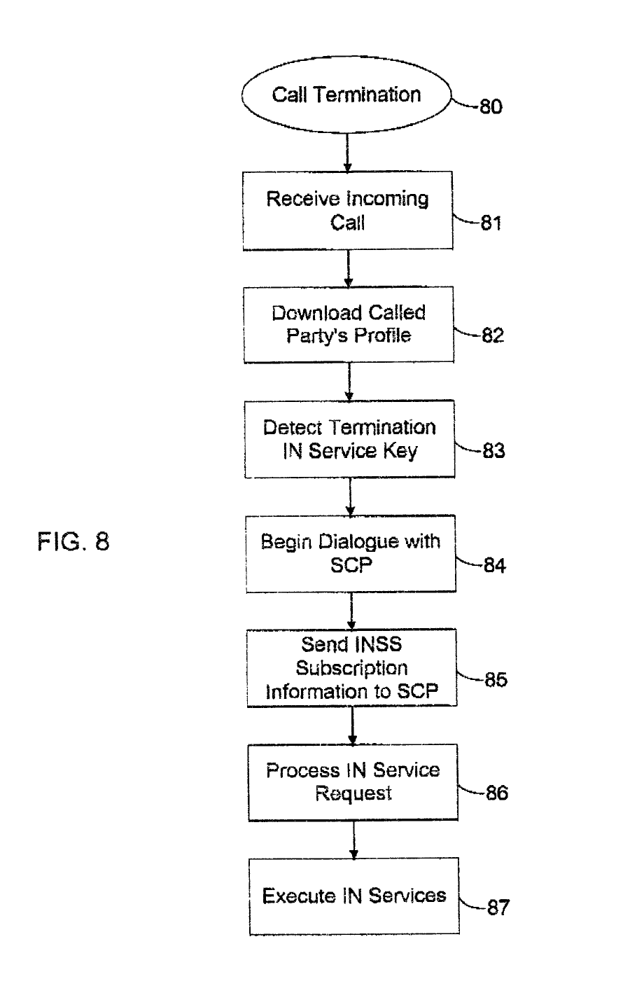

Referring now to FIG. 8, a call termination IN service selection method 80 is shown. The call termination IN service selection method 80 is in all respects virtually identical to the call origination IN service selection method 60 with the exception that a termination IN service key is detected at step 83 instead of an origination IN service key. Therefore, further description of this method is referred to the description of the method of FIGS. 6 and 7A-7B.

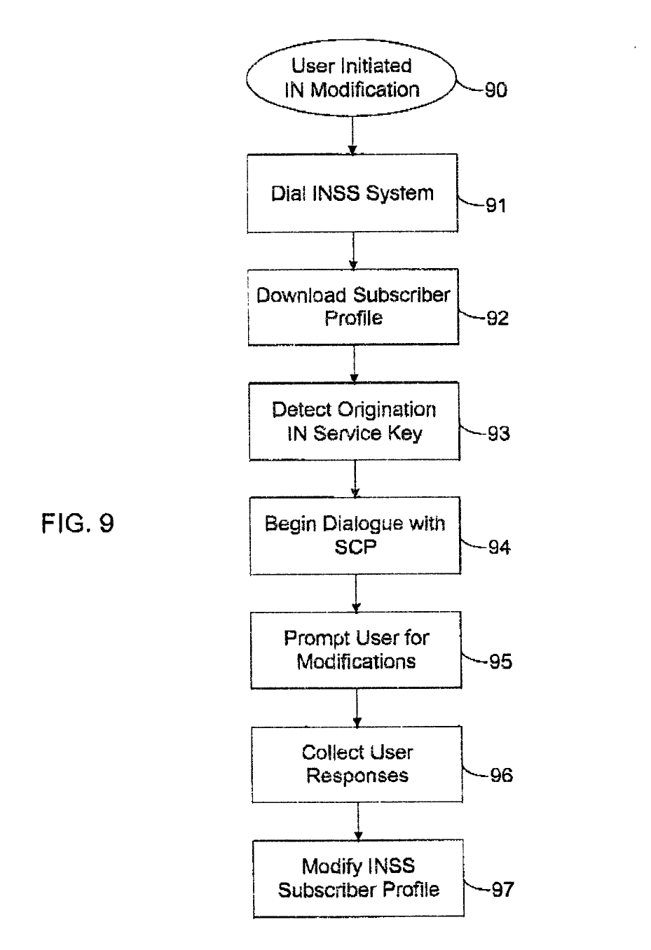

FIG. 9 illustrates a method 90 of modifying the subscriber profile wherein the user initiates the modification. At step 91, the user dials a special number which connects him to the INSS system. At step 92, the MSC which processes the call downloads the user's profile and detects the origination IN service key at step 93. The MSC invokes the SSF, which begins a dialog with the SCP at step 94. At step 95, the INSS residing in the SCP recognizes that the user wishes to modify his subscriber profile (based on the use of the special number) and prompts the user for the new information. At step 96, the user's responses are collected, and at step 97, the INSS modifies the subscriber's profile.

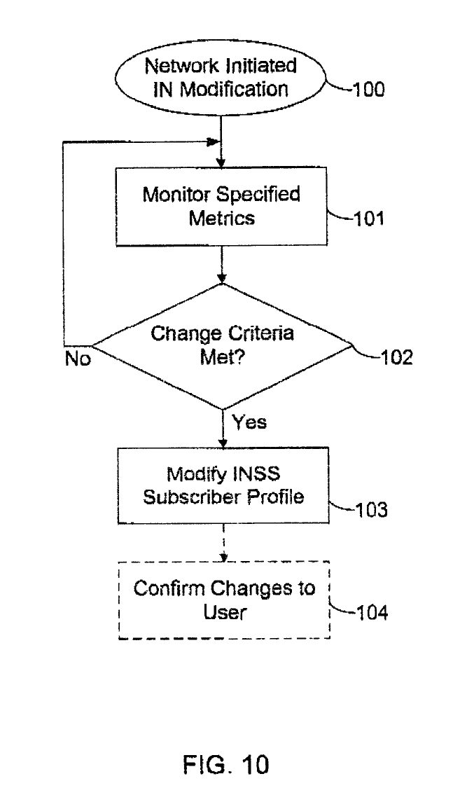

FIG. 10 illustrates a method 100 of modifying an INSS subscription profile wherein the modification is initiated by the SCP. When this method is used, typically the SCP has been instructed to automatically change the subscriber profiles of the users based on some criteria. Thus, at step 101, the SCP monitors the specified metric in question. At step 102, the SCP determines whether the change criteria has been met. If yes, the SCP modifies the INSS subscriber profiles according to some preset specification at step 103. If no, then the SCP goes back to monitoring the specified metric.

Optionally, once the changes have been made, the SCP may confirm these changes to the user at step 94, as shown by the box with the dashed lines.

It should be understood to those skilled in the art, that the description above illustrates one embodiment for implementing the principles of the present invention, and further embodiments are possible. For example, it should be understood that several IN services may be associated with one node (or SCP).

Although a preferred embodiment of the method and system of the present invention has been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for selecting intelligent network services in a mobile telecommunications system, the method comprising the steps of:
connecting a wireless communication to a first network service provider;
requesting at least one intelligent network service be provided to said wireless communication by said first network service provider; and
connecting said wireless communication to a second network service provider via said first network service provider if said at least one intelligent network service cannot be provided to said wireless communication by said first network service provider.

2. The method according to claim 1, wherein said at least one intelligent network service resides at said second network service provider only.

3. The method according to claim 1, wherein said at least one intelligent network service resides at both said first and second network service providers.

4. The method according to claim 1, wherein said first and second network service providers include first and second service control points, respectively.

5. The method according to claim 1, wherein said wireless communication is uniquely associated with said first network service provider.

6. The method according to claim 1, wherein said at least one intelligent network service includes a selected one of at least a mobile virtual private network service and a private prepaid service.

7. The method according to claim 1, further comprising the step of determining which intelligent network service to request for said wireless communication.

8. The method according to claim 7, wherein said step of determining includes accessing a subscription information in a subscriber profile associated with said wireless communication.

9. The method according to claim 8, wherein said subscription information is provided by a user associated with said wireless communication.

10. The method according to claim 8, wherein said subscription information is provided by a network administrator of said first network service provider.

11. The method according to claim 8, wherein said subscription information may be modified by a user associated with said wireless communication.

12. The method according to claim 8, wherein said subscription information may be modified by a network administrator associated with said first network service provider.

13. The method according to claim 7, wherein said step of determining includes collecting input from a user associated with said wireless communication.

14. The method according to claim 13, wherein said input includes a dual-tone multiple-frequency signal.

15. A system for selecting intelligent network services in a mobile telecommunications system, comprising:
a first telecommunications node having a front-end service executing therein;
a mobile switching center configured to connect a wireless communication to said first telecommunications node, said front-end service requesting at least one intelligent network service be provided to said wireless communication by said first telecommunications node; and
a second telecommunications node linked to said first telecommunications node, wherein said front-end service is configured to connect said wireless communication to said second telecommunications node via said first telecommunications node if said at least one intelligent network service cannot be provided to said wireless communication by said first telecommunications node.

16. The system according to claim 15, wherein said at least one intelligent network service resides at said second telecommunications node only.

17. The system according to claim 15, wherein said at least one intelligent network service resides at both said first and second telecommunications nodes.

18. The system according to claim 15, wherein said first and second telecommunications nodes include first and second service control points, respectively.

19. The system according to claim 15, wherein said wireless communication is uniquely associated with said first telecommunications node.

20. The system according to claim 15, wherein said at least one intelligent network service includes a selected one of at least a mobile virtual private network service and a private prepaid service.

21. The system according to claim 15, wherein said front-end service comprises a service routing module for routing said wireless communication to said second telecommunications module.

22. The system according to claim 15, wherein said front-end service comprises a control transfer module for transferring control of said wireless communication to said second telecommunications node.

23. The system according to claim 15, wherein said front-end service comprises a service determination module for determining which intelligent network service to request for said wireless communication.

24. The system according to claim 23, wherein said service determination module determines which intelligent network service to request by accessing a subscription information in a subscriber profile associated with said wireless communication.

25. The system according to claim 24, wherein said subscription information is provided by a user associated with said wireless communication.

26. The system according to claim 24, wherein said subscription information is provided by a network administrator of said first telecommunications node.

27. The system according to claim 24, wherein said subscription information may be modified by a user associated with said wireless communication.

28. The system according to claim 24, wherein said subscription information may be modified by a network administrator associated with said first telecommunications node.

29. The system according to claim 23, wherein said service determination module determines which intelligent network service to request by collecting input from a user associated with said wireless communication.

30. The system according to claim 29, wherein said input includes a dual-tone multiple-frequency signal.
